(19) United States
(12) Patent Application Publication
(10) Pub. No.: US 2013/0207838 A1
(43) Pub. Date: Aug. 15, 2013

(54) ANTENNA DEVICE FOR POSITION DETECTION, POSITION DETECTION DEVICE EQUIPPED WITH THIS ANTENNA DEVICE, AND POSITION DETECTION METHOD

(71) Applicant: Noboru Kobayashi, Okayama (JP)

(72) Inventor: Noboru Kobayashi, Okayama (JP)

(73) Assignee: Noboru KOBAYASHI, Okayama (JP)

(21) Appl. No.: 13/881,285

(22) PCT Filed: Oct. 3, 2011
(86) PCT No.: PCT/JP2011/072733

§ 371 Date: Apr. 24, 2013

(30) Foreign Application Priority Data
Jan. 13, 2011 (JP) 2011-004661

(51) Int. Cl. G01S 19/36; G01S 19/42

(52) U.S. Cl. CPC G01S 19/36; G01S 19/42
USPC 342/357.25; 342/357.76

(57) ABSTRACT

Provided is an antenna device for position detection that can determine the current position, using a GPS receiver with a simple structure, with high accuracy comparable to that of an expensive positioning device, and also provided are a position detection device provided with the antenna device and a position detection method. The current position is determined using a GPS that receives signals from satellites orbiting around the earth and determines the current position. Data communication is performed with an antenna main body including: an antenna member provided, at an end thereof, with a receiving section for receiving signals from the orbiting satellites; and a rotation mechanism for rotating the antenna member circularly in the horizontal direction at a substantially uniform speed. The current position is determined based on the signals from the orbiting satellites that have been received by the receiving section.

### CROSS-REFERENCE TO RELATED APPLICATIONS

This application is a national stage application of PCT Application No. PCT/JP2011/072733, filed Oct. 3, 2011, which claims the benefit of Japanese Application No. 2011-004661, filed Jan. 13, 2011, in the Japanese Intellectual Property Office, the disclosures of which are incorporated herein by reference.

### BACKGROUND OF THE INVENTION

1. Field of the Invention

The present invention relates to an antenna device for position detection that can determine the current position with high accuracy using a GPS (Global Positioning System), a position detection device equipped with this antenna device, and a position detection method.

2. Description of the Related Art

Many position detection devices that determine one's current position anywhere in the world using a GPS (Global Positioning System) have been developed. Since a GPS can maintain a positioning accuracy with an error around a little more than 10 meters, it has been used for many car navigation systems, etc.

However, for example, when one gets lost during mountaineering, a positioning error of a few meters can be crucial and it is required to determine the current position with higher accuracy.

Therefore, as is the case with a DGPS (Deferential Global Positioning System; Deferential GPS) that corrects the current position determined also with the result of communication with a base station whose exact location is known, there are an increasing number of positioning devices that perform complicated post-processing to improve the positioning accuracy. Such positioning devices are expensive but have a positioning accuracy improved to have an error of only a few centimeters by calculating the positioning error with higher accuracy.

As a method of reducing the positioning error caused by a reflected wave in a positioning device that uses a GPS, Patent Document 1 discloses a positioning device that rotates an aerial mechanically or electrically in order to separate the carrier frequency transmitted from GPS satellites. This allows a right circularly polarized wave and a left circularly polarized wave to be separated from each other, and thereby the positioning error caused by the reflected wave can be reduced effectively.

Furthermore, devices that can correct the moving direction even with lower positioning accuracy also have been disclosed. For example, in the device disclosed in Patent Document 2, the strut of a receiver is oriented vertically and the receiver is held in such a manner as to rotate around the horizontal axis. Whenever the receiver moves, the moving direction of the receiver is rotated to the direction of a target position. This allows the receiver to ultimately reach the target position regardless of how much the position of the receiver was fluctuated along the path.

### Patent Documents

[Patent Document 1] JP 10-253735 A

[Patent Document 2] JP 10-300466 A

### SUMMARY OF THE INVENTION

However, each of the devices has a large-scale structure and also is expensive. Therefore, it is difficult for general consumers to use them, which has been a problem. Particularly, for example, in the case of having got lost during mountaineering, usually such a device with a large structure is not available. Thus, there are demands for the development of position detection devices for general customers.

The present invention was made with such situations in mind. The present invention is intended to provide an antenna device for position detection that can determine the current position with high accuracy using a GPS with a simple structure, a position detection device equipped with this antenna device, and a position detection method.

In order to achieve the above-mentioned object, a position detection device according to a first invention determines a current position using a GPS that receives a signal from a satellite orbiting around the earth to determine the current position, wherein the position detection device is capable of data communication with an antenna main body that comprises an antenna member provided, at an end thereof, with a receiving section for receiving the signal from the orbiting satellite and a rotation mechanism for rotating the antenna member circularly in a horizontal direction at a substantially uniform speed, and the position detection device receives the signal from the orbiting satellite received by the receiving section.

A position detection device according to a second invention is characterized by comprising, in the first invention, a calculation means that calculates a coordinate value of the current position based on the signal received from the orbiting satellite, a locus information storage means that stores locus information about a locus of the coordinate value of the current position that has been calculated, an approximation means that approximates the locus of the coordinate value of the current position to a perfect circle based on the locus information that has been stored, and an output means that outputs, as a coordinate value of the current position, a center coordinate value of the perfect circle obtained by the approximation.

Furthermore, a position detection device according to a third invention is characterized in that in the first invention, the antenna member rotates about an approximate center thereof in the horizontal direction and is provided, at each end thereof, with the receiving section.

A position detection device according to a fourth invention is characterized by comprising, in the third invention, a calculation means that calculates coordinate values of the current position based on the signals from the orbiting satellite received by the receiving sections, respectively, a locus information storage means that calculates the average coordinate value of the coordinate values of the current position that have been calculated and stores locus information about a locus of the average coordinate value that has been calculated, an approximation means that approximates the locus information of the current position to a perfect circle based on the locus information that has been stored, and an output means that outputs, as a coordinate value of the current position, a center coordinate value of the perfect circle obtained by the approximation.

A position detection device according to a fifth invention is characterized in that in the second or fourth invention, the approximation means selects locus information for a predetermined period of time from the locus information that has been stored and then approximates it to a perfect circle.

Next, in order to achieve the above-mentioned object, a position detection method according to a sixth invention is a method for determining a current position using a GPS that receives a signal from a satellite orbiting around the earth to determine the current position, wherein the position detection method comprises a step of rotating an antenna member circularly in a horizontal direction at a substantially uniform speed, which is provided, at an end thereof, with a receiving section for receiving the signal from the orbiting satellite, and a step of receiving the signal from the orbiting satellite by the receiving section, with the antenna member being rotated.

The position detection method according to a seventh invention is characterized by comprising, in the sixth invention, a step of calculating a coordinate value of the current position based on the signal received from the orbiting satellite, a step of storing locus information about a locus of the coordinate value of the current position that has been calculated, a step of approximating the locus of the coordinate value of the current position to a perfect circle based on the locus information that has been stored, and a step of outputting, as a coordinate value of the current position, a center coordinate value of the perfect circle obtained by the approximation.

Furthermore, a position detection method according to an eighth invention is characterized in that in the sixth invention, the antenna member rotates about an approximate center thereof in the horizontal direction and is provided, at each end thereof, with the receiving section.

A position detection method according to a ninth invention is characterized by comprising, in the eighth invention, a step of calculating coordinate values of the current position based on the signals from the orbiting satellite received by the receiving sections, respectively, a step of calculating the average coordinate value of the coordinate values of the current position that have been calculated and storing locus information about a locus of the average coordinate value that has been calculated, a step of approximating the locus information of the current position to a perfect circle based on the locus information that has been stored, and a step of outputting, as a coordinate value of the current position, a center coordinate value of the perfect circle obtained by the approximation.

A position detection method according to a tenth invention is characterized in that in the seventh or ninth invention, locus information for a predetermined period of time is selected from the locus information that has been stored and then is approximated to a perfect circle.

Next, in order to achieve the above-mentioned object, an antenna device for position detection according to an eleventh invention receives a signal from a satellite orbiting around the earth and transmits, based on the signal thus received, a signal indicating a current position to a position detection device, wherein the antenna device comprises an antenna member provided, at an end thereof, with a receiving section for receiving the signal from the orbiting satellite and a rotation mechanism for rotating the antenna member circularly in a horizontal direction at a substantially uniform speed.

An antenna device for position detection according to a twelfth invention is characterized by comprising, in the eleventh invention, a calculation means that calculates a coordinate value of the current position based on the signal received from the orbiting satellite, a locus information storage means that stores locus information about a locus of the coordinate value of the current position that has been calculated, an approximation means that approximates the locus of the coordinate value of the current position to a perfect circle based on the locus information that has been stored, and an output means that outputs, as a signal indicating the current position, a center coordinate value of the perfect circle obtained by the approximation to the position detection device.

An antenna device for position detection according to a thirteenth invention is characterized in that in the eleventh invention, the antenna member rotates about an approximate center thereof in the horizontal direction and is provided, at each end thereof, with the receiving section.

An antenna device for position detection according to a fourteenth invention is characterized by comprising, in the thirteenth invention, a calculation means that calculates coordinate values of the current position based on the signals from the orbiting satellite received by the receiving sections, respectively, a locus information storage means that calculates the average coordinate value of the coordinate values of the current position that have been calculated and stores locus information about a locus of the average coordinate value that has been calculated, an approximation means that approximates the locus of the current position to a perfect circle based on the locus information that has been stored, and an output means that outputs, as a signal indicating the current position, a center coordinate value of the perfect circle obtained by the approximation to the position detection device.

In the first and sixth inventions, the current position is determined using a GPS that receives the signal from the satellite orbiting around the earth to determine the current position. Data communication can be performed with the antenna main body that comprises the antenna member provided, at an end thereof, with the receiving section for receiving the signal from the orbiting satellite and the rotation mechanism for rotating the antenna member circularly in the horizontal direction at a substantially uniform speed. Since the position detection device receives the signal from the orbiting satellite received by the receiving section, the coordinate value of the current position calculated based on the signal that has been received forms a substantially circular locus. The center coordinate value of the perfect circle obtained by the approximation of the locus of the coordinate value of the current position is determined as the coordinate value of the current position. This reduces the positioning error caused by, for example, the fluctuation resulting from satellite movement inherent to GPS. Thus the current position can be determined with higher accuracy.

In the second and seventh inventions, the coordinate value of the current position is calculated based on the signal received from the orbiting satellite, and the locus information about the locus of the coordinate value of the current position that has been calculated is stored. The locus of the coordinate value of the current position is approximated to a perfect circle based on the locus information that has been stored, and the center coordinate value of the perfect circle obtained by the approximation is outputted as the coordinate value of the current position. This reduces the positioning error caused by, for example, the fluctuation resulting from satellite movement inherent to GPS. Thus the current position can be determined with higher accuracy.

In the third and eighth inventions, the antenna member rotates about the approximate center thereof in the horizontal direction and is provided, at both ends thereof, with the receiving sections that receive the signals from the orbiting satellite. Therefore, the current position can be determined based on the two signals obtained by measuring of the same position. Thus, the current position can be determined with higher accuracy.

In the fourth and ninth inventions, the coordinate values of the current position are calculated based on the signals from the orbiting satellite received by the receiving sections, respectively, and the average coordinate value of the coordinate values of the current position that have been calculated is calculated, and the locus information about the locus of the average coordinate value that has been calculated is stored. The locus information of the current position is approximated to a perfect circle based on the locus information that has been stored, and the center coordinate value of the perfect circle obtained by the approximation is outputted as the coordinate value of the current position. Since the center coordinate value of the perfect circle obtained by the approximation of the locus of the average coordinate value of the coordinate values calculated based on a plurality of signals obtained by measuring of the same position is outputted as the coordinate value of the current position, the current position can be determined with higher accuracy.

In the fifth and tenth inventions, the locus information for a predetermined period of time is selected from the locus information that has been stored and then is approximated to a perfect circle. Therefore, the approximation can be performed, with a reduction in positioning error caused by fluctuation that tends to occur in the early stage of position determination. Thus, the approximation precision can be improved.

In the eleventh invention, the antenna device receives a signal from a satellite orbiting around the earth and based on the signal thus received, a signal indicating the current position is transmitted to the position detection device. Since the antenna device comprises the antenna member provided, at an end thereof, with the receiving section for receiving the signal from the orbiting satellite and the rotation mechanism for rotating the antenna member circularly in the horizontal direction at a substantially uniform speed, the coordinate value of the current position calculated based on the signal that has been received forms a substantially circular locus, and the center coordinate value of the perfect circle obtained by the approximation of the locus of the coordinate value of the current position is determined as the coordinate value of the current position. This reduces the positioning error caused by, for example, the fluctuation resulting from satellite movement inherent to GPS. Thus the current position can be determined with higher accuracy.

In the twelfth invention, the coordinate value of the current position is calculated based on the signal received from the orbiting satellite, and the locus information about the locus of the coordinate value of the current position that has been calculated is stored. The locus of the coordinate value of the current position is approximated to a perfect circle based on the locus information that has been stored, and the center coordinate value of the perfect circle obtained by the approximation is outputted to the position detection device as the signal indicating the current position. Therefore, by externally attaching the antenna device to a position detection device that uses a conventional GPS, the accuracy of determining the current position can be improved easily.

In the thirteenth invention, the antenna member rotates about the approximate center thereof in the horizontal direction and receives the signals from the orbiting satellite by the receiving sections provided at both ends thereof. The current position can be determined based on two signals obtained by measuring the same position. Therefore, the current position can be determined with higher accuracy.

In the fourteenth invention, the coordinate values of the current position are calculated based on the signals from the orbiting satellite received by the receiving sections, respectively, the average coordinate value of the coordinate values of the current position that have been calculated is calculated, and the locus information about the locus of the average coordinate value that has been calculated is stored. The locus of the current position is approximated to a perfect circle based on the locus information that has been stored, and the center coordinate value of the perfect circle obtained by the approximation is outputted to the position detection device as the signal indicating the current position. Since the center coordinate value of the perfect circle obtained by the approximation of the locus of the average coordinate value of the coordinate values calculated based on a plurality of signals obtained by measuring the same position is outputted as the coordinate value of the current position, the current position can be determined with higher accuracy.

According to the present invention, since the signal from the orbiting satellite received by the receiving section is received, the coordinate value of the current position calculated based on the signal that has been received forms a substantially circular locus, and the center coordinate value of the perfect circle obtained by the approximation of the locus of the coordinate value of the current position is determined as the coordinate value of the current position. This reduces the positioning error caused by, for example, the fluctuation resulting from satellite movement inherent to GPS. Thus the current position can be determined with higher accuracy.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view showing the configuration of a position detection device according to Embodiment 1 of the present invention.

FIG. 2 is a functional block diagram showing the configuration of the position detection device according to Embodiment 1 of the present invention.

FIG. 3 is an illustrative view showing a method of displaying tracking data and a current position in a conventional position detection device.

FIG. 4 is an illustrative view showing a method of displaying tracking data and a current position in the position detection device according to Embodiment 1 of the present invention.

FIG. 5 is an illustrative view showing a method of displaying tracking data and a current position in the position detection device according to Embodiment 1 of the present invention.

FIG. 6 is a schematic view showing the configuration of a position detection device according to Embodiment 2 of the present invention.

FIG. 7 is a functional block diagram showing the configuration of the position detection device according to Embodiment 2 of the present invention.

FIG. 8 is a schematic view showing the configuration of an antenna device according to Embodiment 3 of the present invention.

FIG. 9 is a functional block diagram showing the configuration of the antenna device according to Embodiment 3 of the present invention.

FIG. 10 is a schematic view showing the configuration of a position detection device according to Embodiment 4 of the present invention.

FIG. 11 is a functional block diagram showing the configuration of the position detection device according to Embodiment 4 of the present invention.

FIG. 12 is an illustrative view showing a method of displaying tracking data and a current position in the position detection device 1 according to Embodiment 4 of the present invention.

FIG. 13 is a schematic view showing the configuration of an antenna device according to Embodiment 5 of the present invention.

FIG. 14 is a functional block diagram showing the configuration of the antenna device according to Embodiment 5 of the present invention.

FIG. 15 is a schematic view showing the configuration of an antenna device according to Embodiment 6 of the present invention.

FIG. 16 is a functional block diagram showing the configuration of the antenna device according to Embodiment 6 of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, position detection devices according to embodiments of the present invention are described with reference to the drawings. Throughout the drawings to be referred, components with the same or similar configuration or function are indicated with the same or similar numbers and descriptions thereof are not repeated.

### Embodiment 1

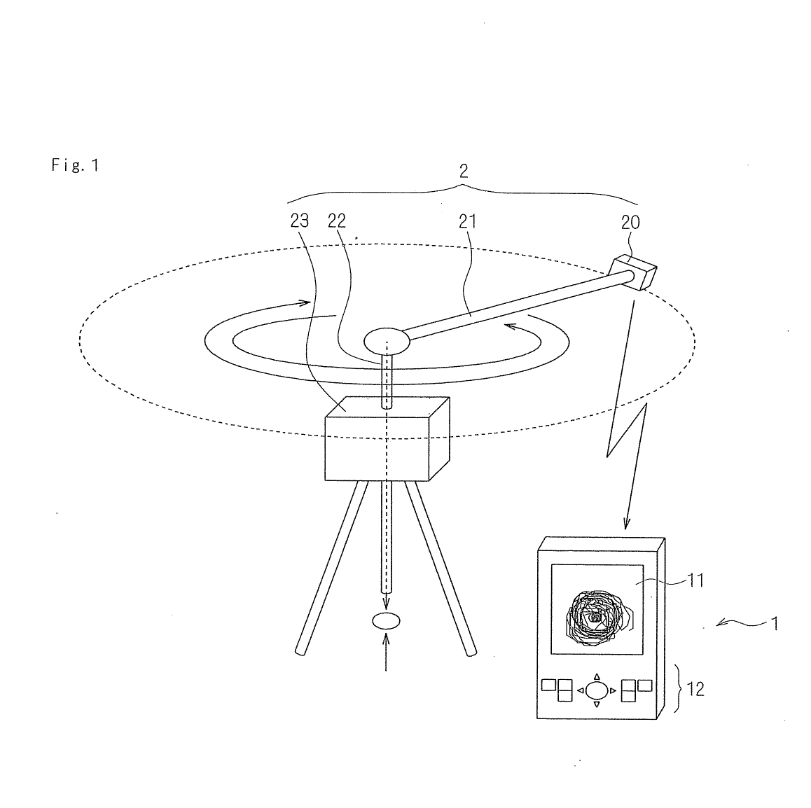

FIG. 1 is a schematic view showing the configuration of a position detection device according to Embodiment 1 of the present invention. As shown in FIG. 1, the position detection device 1 according to Embodiment 1 determines the current position using a GPS that receives signals from satellites orbiting around the earth to determine the current position.

The position detection device 1 is provided with an antenna main body 2 that receives signals from orbiting satellites, in such a manner as to be capable of data communication therewith, and receives the signals from the orbiting satellites received by the antenna main body 2. The antenna main body 2 rotates an antenna member 21 circularly in the horizontal direction at a substantially uniform speed through a rotating shaft 22. Furthermore, the antenna member 21 is provided, at an end thereof, with a GPS chip (a receiving section) 20 for receiving signals from satellites orbiting around the earth and is rotated by a swing device 23 provided with a drive source such as an electric motor as described later.

The result of determining the current position is displayed on a display section 11 as a coordinate value or with a coordinate value and map information overlapping each other. Various operations of the position detection device 1 are performed through an operation section 12.

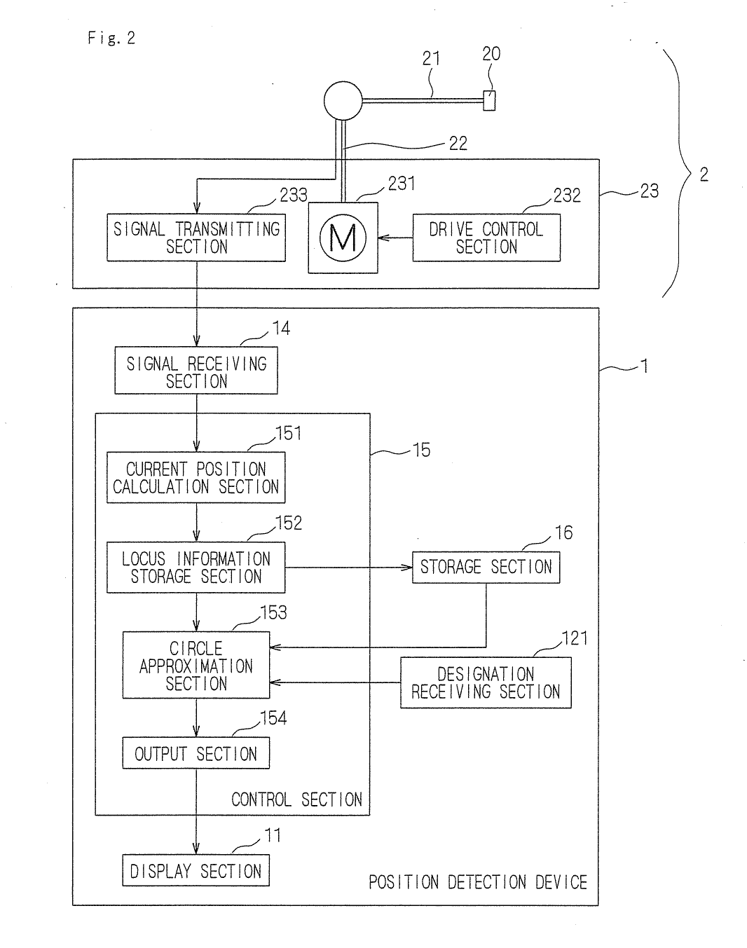

FIG. 2 is a functional block diagram showing the configuration of the position detection device 1 according to Embodiment 1 of the present invention. An electric motor (a rotation mechanism) 231 contained in the swing device 23 of the antenna main body 2 rotates the rotating shaft 22 based on a signal transmitted from a built-in drive control section 232. The antenna member 21 connected to the end of the rotating shaft 22 rotates circularly in the horizontal direction at a substantially uniform speed by the rotation of the rotating shaft 22. The GPS chip 20 provided at the end of the antenna member 21 also rotates circularly in the horizontal direction at a substantially uniform speed.

The signals received by the GPS chip 20 of the antenna main body 2 are transmitted to the position detection device 1 through a signal transmitting section 233. The transmission of the signals from the signal transmitting section 233 to the position detection device 1 can be performed either by wired or by wireless.

The signals received by the GPS chip 20 of the antenna main body 2 are received by a signal receiving section 14 of the position detection device 1 to be transmitted to a control section 15. A current position calculation section 151 of the control section 15 calculates the coordinate value of the current position based on the signals from orbiting satellites received by the GPS chip 20 of the antenna main body 2. The method of calculating the coordinate value of the current position is not particularly limited as long as it is a well-known method.

A locus information storage section 152 stores, as tracking data, locus information about a locus of the coordinate values of the current position, which have been calculated, in a storage section 16 in chronological order. By storing it in the storage section 16 in chronological order, the tracking data to be used for determining the current position can be selected. The tracking data to be stored in the storage section 16 is information about a locus of the coordinate values of the current position obtained per sampling time.

When the tracking data is displayed on the display section 11, it may be displayed as a point sequence of coordinate values of the current position obtained per sampling time or may be displayed after linear interpolation, spline interpolation, etc. are performed on the coordinate values of the current position obtained per sampling time.

A circle approximation section 153 approximates the tracking data stored in the storage section 16 to a perfect circle by using a well-known mathematical technique. The approximation may be performed on the tracking data obtained from the start of determining the current position or only on the tracking data obtained during the period designated through a designation receiving section 121 of the operation section 12. This allows the approximation to be performed, with a reduction in positioning error caused by the fluctuation that tends to occur in the early stage of position determination. Thus the approximation precision can be improved.

An output section 154 outputs the center coordinate value of the perfect circle obtained by the approximation by the circle approximation section 153 to the display section 11 as the coordinate value of the current position. On the display section 11, the current position may be displayed by, for example, latitude and longitude or may be displayed graphically together with map information.

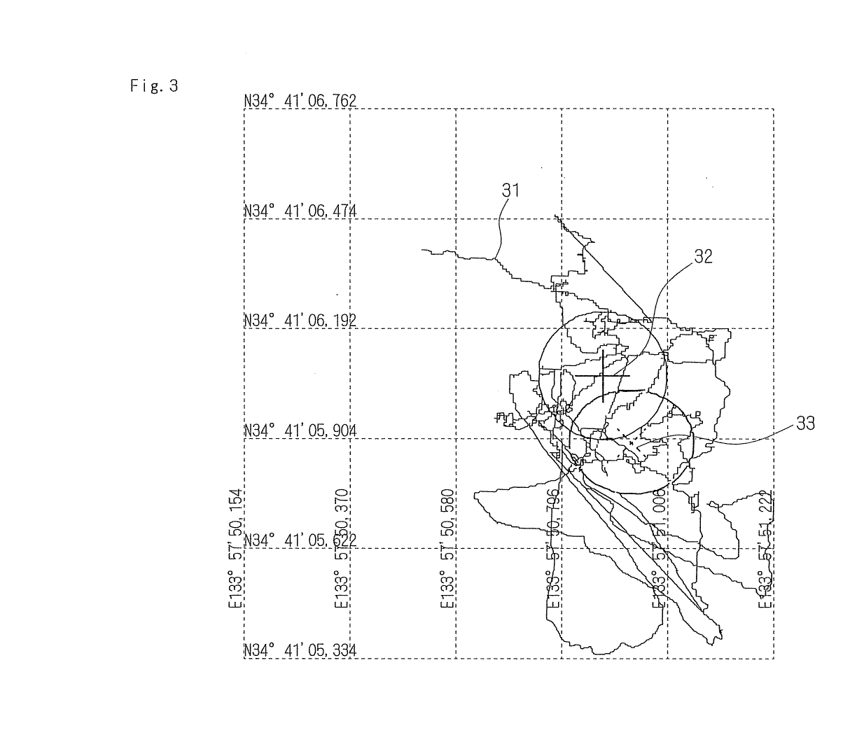

FIG. 3 is an illustrative view showing a method of displaying tracking data and a current position in a conventional position detection device. FIG. 3 shows tracking data 31 obtained based on the signals received by a conventional GPS, the current position 32 that has been determined, and the true position 33. The tracking data 31 displayed is obtained through linear interpolation of the coordinate values of the current position obtained per sampling time.

As shown in FIG. 3, the tracking data 31 obtained based on the signals received by the conventional GPS is affected significantly by the movement of orbiting satellites and other factors and thereby has moved around the true position 33 randomly. In the example shown in FIG. 3, the current position 32 has been determined as the average coordinate value of the coordinate values of the tracking data 31. However, the current position 32 that has been determined deviates significantly from the true position 33 indicated as the center of an ellipse.

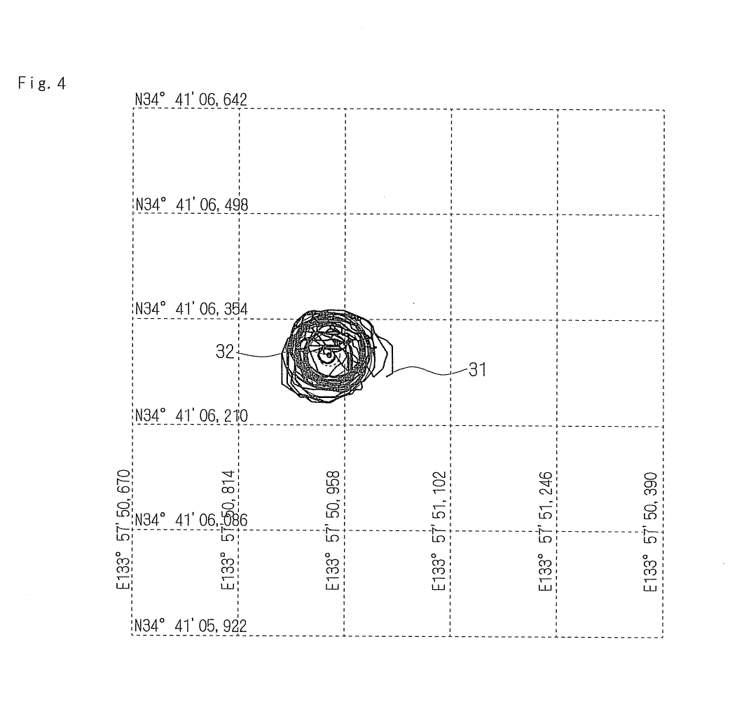

FIG. 4 is an illustrative view showing a method of displaying tracking data and a current position in the position detection device 1 according to Embodiment 1 of the present invention. FIG. 4 shows tracking data 31 obtained based on the signals received by the GPS chip 20 when the antenna member 21 was rotated circularly in the horizontal direction at a substantially uniform speed and the current position 32 that has been determined. The tracking data 31 displayed is obtained through linear interpolation of the coordinate values of the current position obtained per sampling time.

As shown in FIG. 4, with the antenna member 21 rotated circularly in the horizontal direction at a substantially uniform speed, the tracking data 31 moves circularly about the true position 33. That is, with the antenna member 21 being rotated about the rotating shaft 22 circularly in the horizontal direction at a substantially uniform speed, the signals from orbiting satellites are received by the GPS chip 20, so that the locus of the coordinate values of the current position calculated based on the signals that have been received has a substantially circular shape. Therefore, the tracking data 31 can be approximated to a perfect circle with high precision and the center coordinate value of the perfect circle obtained by the approximation can be determined as the coordinate value of the current position, which makes it possible to determine the current position with high accuracy.

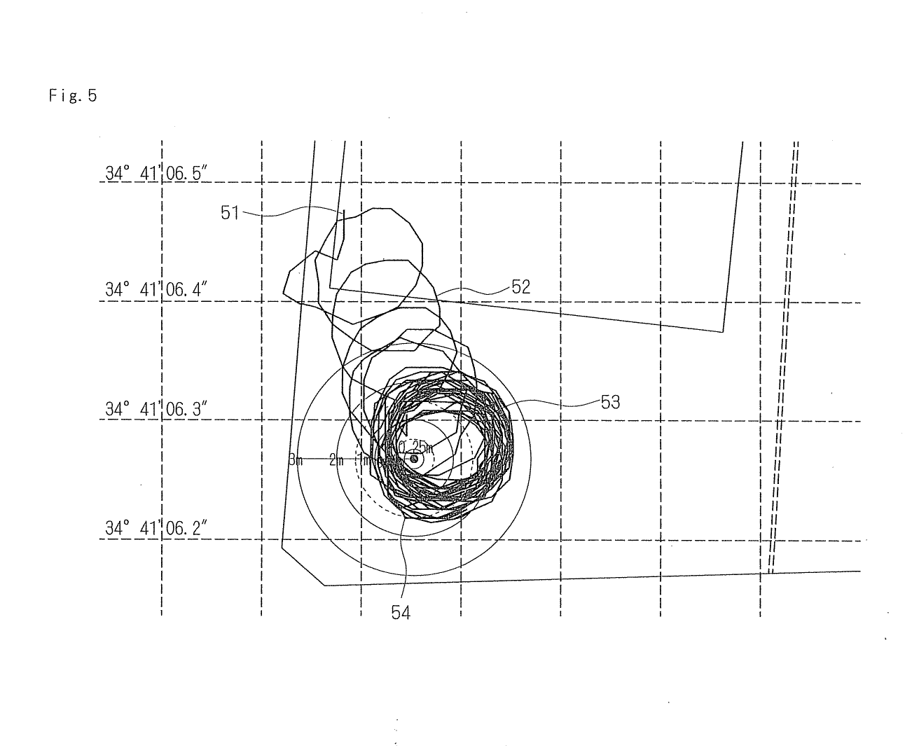

FIG. 5 is an illustrative view showing a method of displaying tracking data and a current position in the position detection device 1 according to Embodiment 1 of the present invention. Actually, as shown in FIG. 4, the tracking data 31 rarely moves circularly about the true position 33. Usually, from the point of time when the antenna member 21 achieves steady rotation after starting rotating, the locus of the coordinate values of the current position gradually approaches a circular shape.

In FIG. 5, the sampling time is every one second and the antenna member 21 has a turning radius of 1.5 m. In the example of FIG. 5, for a while after sampling of the tracking data starts from a tracking start point 51, it has moved substantially circularly as shown with a tracking data 52 but has not moved about a certain center. Thereafter, it gradually converges on a tracking data 53 with a circular shape formed about one point. However, it is decentered slightly to the right due to the occurrence of fluctuation resulting from the movement of orbiting satellites, the difference in air density, etc.

With a further continuation of the sampling of the tracking data, it can converge on a tracking data 54 which is similar to that obtained when fluctuation correction is performed. Accordingly, it is possible to determine the current position with high accuracy without performing advanced arithmetic processing such as the fluctuation correction.

It should be understood that the means for rotating the antenna member 21 is not limited to the electric motor 231 and it may be rotated by another drive source or an operator holding the position detection device 1 himself may rotate it circularly in a substantially horizontal direction at a substantially uniform speed so as to allow the tracking data to have a substantially circular shape.

As described above, according to Embodiment 1, signals are received from orbiting satellites, with the antenna member 21 provided, at an end thereof, with the GPS chip (the receiving section) 20 that receives the signals being rotated circularly in the horizontal direction at a substantially uniform speed. The coordinate values of the current position calculated based on the signals that have been received form a substantially circular locus. Then the center coordinate value of the perfect circle obtained by the approximation of the locus of the coordinate values of the current position is determined as the coordinate value of the current position. This reduces the positioning error caused by, for example, the fluctuation resulting from satellite movement inherent to GPS. Thus the current position can be determined with higher accuracy.

### Embodiment 2

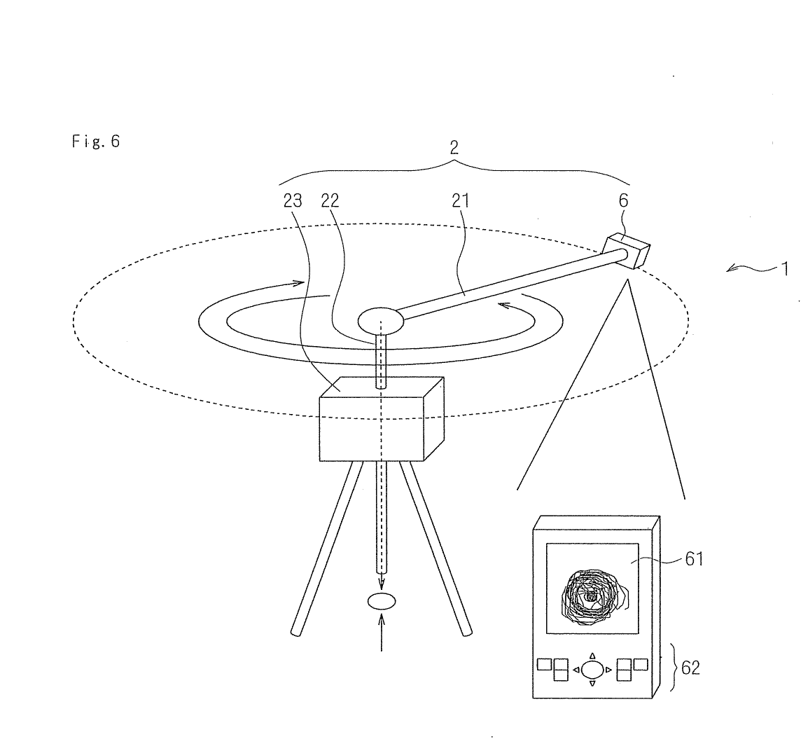

FIG. 6 is a schematic view showing the configuration of a position detection device 1 according to Embodiment 2 of the present invention. As shown in FIG. 6, the position detection device 1 according to Embodiment 2 is different from that of Embodiment 1 in that a conventional GPS device 6 is provided at an end of an antenna member 21 and is rotated together with the antenna member 21. The components and members with the same functions are indicated with the same numbers and detailed descriptions thereof are not repeated.

An antenna main body 2 rotates the antenna member 21 circularly in the horizontal direction at a substantially uniform speed through a rotating shaft 22. The antenna member 21 is rotated by a drive source such as an electric motor as described later that is contained in a swing device 23. It should be understood that the means for rotating the antenna member 21 is not limited to the electric motor and it may be rotated by another drive source or an operator holding the position detection device 1 himself may rotate it circularly in a substantially horizontal direction at a substantially uniform speed so as to allow the tracking data to have a substantially circular shape.

The result of determining the current position is displayed on a display section 61 of the GPS device 6 as a coordinate value or with a coordinate value and map information overlapping each other. Various operations of the GPS device 6 are performed through an operation section 62.

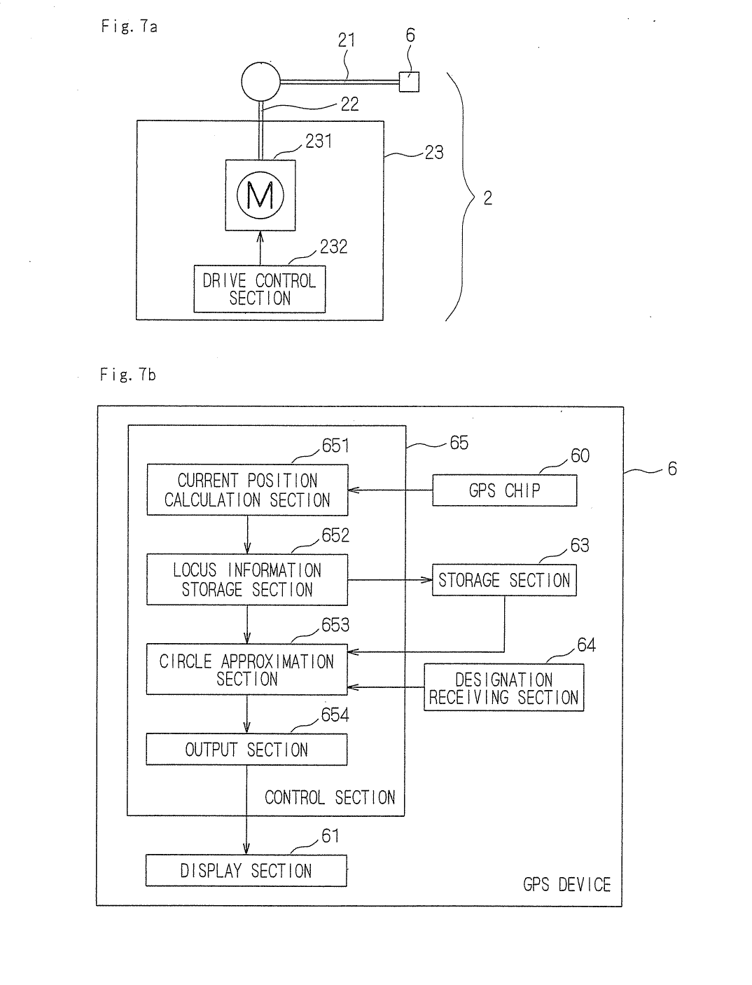

FIG. 7 is a functional block diagram showing the configuration of the position detection device 1 according to Embodiment 2 of the present invention. FIG. 7A is a functional block diagram showing the configuration of the antenna main body 2 of the position detection device 1 according to Embodiment 2 of the present invention. As shown in FIG. 7A, the rotating shaft 22 is rotated by an electric motor (a rotation mechanism) 231 contained in the swing device 23 of the antenna main body 2. The antenna member 21 connected to the end of the rotating shaft 22 rotates circularly in the horizontal direction at a substantially uniform speed by the rotation of the rotating shaft 22. The GPS device 6 provided at the end of the antenna member 21 also rotates circularly in the horizontal direction at a substantially uniform speed.

FIG. 7B is a functional block diagram showing the configuration of the GPS device 6 of the position detection device 1 according to Embodiment 2 of the present invention. As shown in FIG. 7B, a signal received by a GPS chip (a receiving section) 60 of the rotating GPS device 6 is transmitted to a control section 65. A current position calculation section 651 of the control section 65 calculates the coordinate value of the current position based on the signals from orbiting satellites received by the GPS chip 60. The method of calculating the coordinate value of the current position is not particularly limited as long as it is a well-known method.

A locus information storage section 652 stores, as tracking data, locus information about a locus of the coordinate values of the current position, which have been calculated, in a storage section 63 in chronological order. By storing it in the storage section 63 in chronological order, the tracking data to be used for determining the current position can be selected. The tracking data to be stored in the storage section 63 is information about a locus of the coordinate values of the current position obtained per sampling time.

When the tracking data is displayed on the display section 61 of the GPS device 6, it may be displayed as a point sequence of coordinate values of the current position obtained per sampling time or may be displayed after linear interpolation, spline interpolation, etc. are performed on the coordinate values of the current position obtained per sampling time.

A circle approximation section 653 approximates the tracking data stored in the storage section 63 to a perfect circle by using a well-known mathematical technique. The approximation may be performed on the tracking data obtained from the start of determining the current position or only on the tracking data obtained during the period designated through a designation receiving section 64 of the operation section 62. This allows the approximation to be performed, with a reduction in positioning error caused by the fluctuation that tends to occur in the early stage of position determination. Thus the approximation precision can be improved.

An output section 654 outputs the center coordinate value of the perfect circle obtained by the approximation by the circle approximation section 653 to the display section 61 as the coordinate value of the current position. On the display section 61, the current position may be displayed by, for example, latitude and longitude or may be displayed graphically together with map information.

As described above, according to Embodiment 2, signals are received from orbiting satellites, with the antenna member 21 provided, at an end thereof, with the GPS chip (the receiving section) 60 that receives the signals being rotated circularly in the horizontal direction at a substantially uniform speed. The coordinate values of the current position calculated based on the signals that have been received form a substantially circular locus. Then the center coordinate value of the perfect circle obtained by the approximation of the locus of the coordinate values of the current position is determined as the coordinate value of the current position. This reduces the positioning error caused by, for example, the fluctuation resulting from satellite movement inherent to GPS. Thus the current position can be determined with higher accuracy.

### Embodiment 3

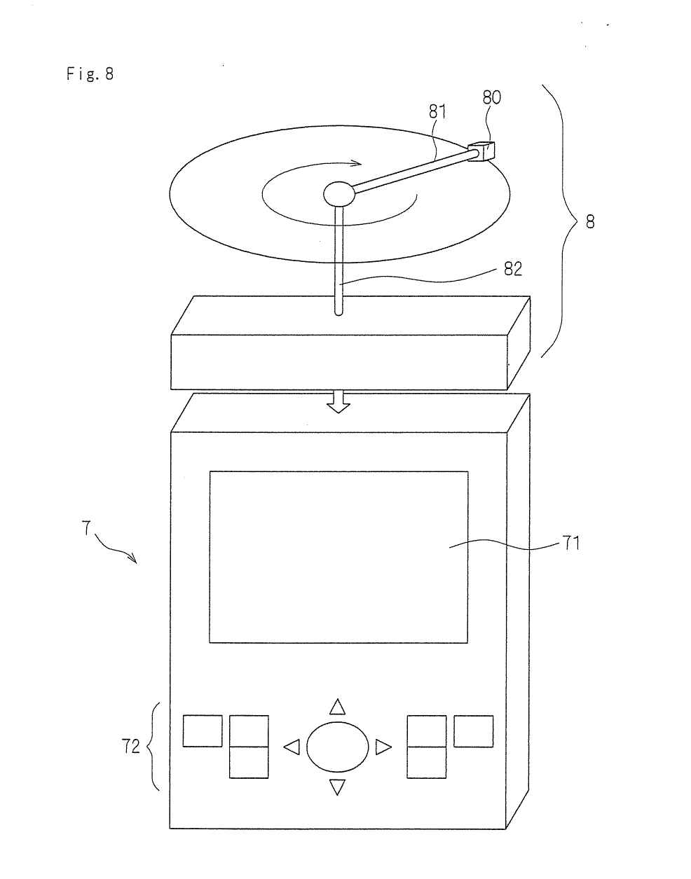

FIG. 8 is a schematic view showing the configuration of an antenna device according to Embodiment 3 of the present invention. As shown in FIG. 8, the antenna device 8 according to Embodiment 3 receives signals from satellites orbiting around the earth and outputs a signal indicating the current position based on the signals that have been received, to a position detection device 7.

The antenna device 8 circularly rotates an antenna member 81, which receives signals from orbiting satellites, through a rotating shaft 82 in the horizontal direction at a substantially uniform speed. The antenna member 81 is provided, at an end thereof, with a GPS chip (a receiving section) 80 that receives signals from satellites orbiting around the earth and is rotated by a drive source such as an electric motor as described later.

The result of determining the current position is outputted to the position detection device 7 as a signal indicating the current position. The position detection device 7 that has received the signal indicating the current position displays the result of determining the current position on a display section 71 as a coordinate value or by a coordinate value and map information overlapping each other. Various operations of the position detection device 7 are performed through an operation section 72.

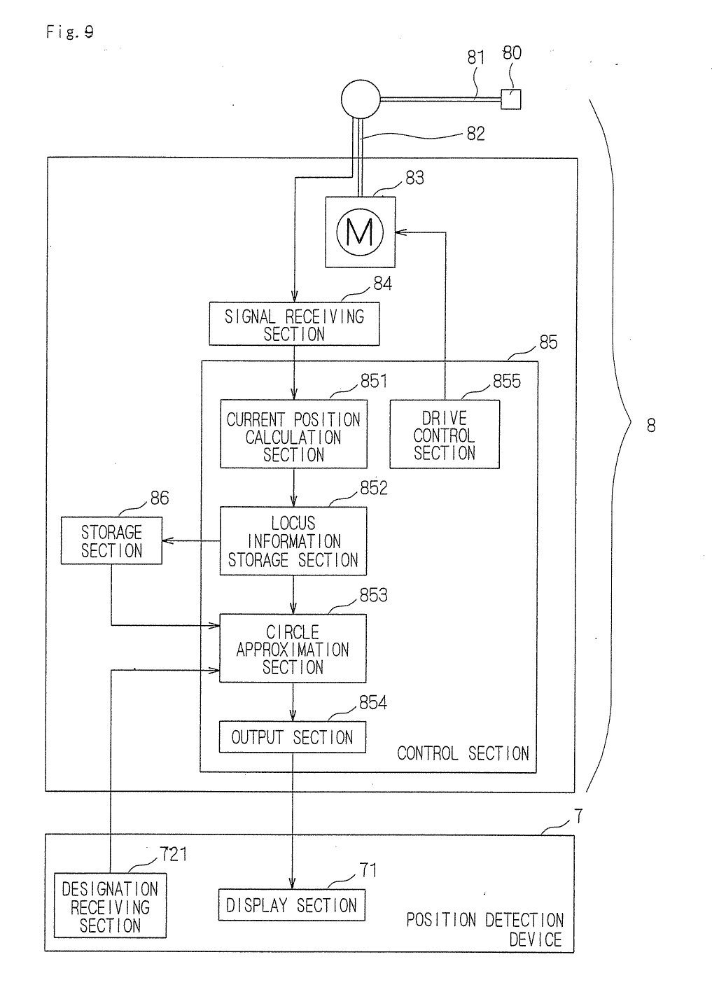

FIG. 9 is a functional block diagram showing the configuration of the antenna device 8 according to Embodiment 3 of the present invention. An electric motor (a rotation mechanism) 83 contained in the antenna device 8 rotates the rotating shaft 82 based on a signal transmitted from a drive control section 855 of a control section 85. The antenna member 81 connected to the end of the rotating shaft 82 rotates circularly in the horizontal direction at a substantially uniform speed by the rotation of the rotating shaft 82.

Signals received by the GPS chip 80 of the antenna member 81 are received by a signal receiving section 84 to be transmitted to the control section 85. A current position calculation section 851 of the control section 85 calculates the coordinate value of the current position based on the signals from orbiting satellites received by the GPS chip 80. The method of calculating the coordinate value of the current position is not particularly limited as long as it is a well-known method.

A locus information storage section 852 stores, as tracking data, locus information about a locus of the coordinate values of the current position, which have been calculated, in a storage section 86 in chronological order. By storing it in the storage section 86 in chronological order, the tracking data to be used for determining the current position can be selected. The tracking data to be stored in the storage section 86 is information about a locus of the coordinate values of the current position obtained per sampling time.

When the tracking data is displayed on the display section 71 of the position detection device 7, it may be displayed as a point sequence of coordinate values of the current position obtained per sampling time or may be displayed after linear interpolation, spline interpolation, etc. are performed on the coordinate values of the current position obtained per sampling time.

A circle approximation section 853 approximates the tracking data stored in the storage section 86 to a perfect circle by using a well-known mathematical technique. The approximation may be performed on the tracking data obtained from the start of determining the current position or only on the tracking data obtained during the period designated through a designation receiving section 721 of the operation section 72. This allows the approximation to be performed, with a reduction in positioning error caused by the fluctuation that tends to occur in the early stage of position determination. Thus the approximation precision can be improved.

An output section 854 outputs the center coordinate value of the perfect circle obtained by the approximation by the circle approximation section 853 to the position detection device 7 as a signal indicating the current position. The position detection device 7 that has received the center coordinate value of the perfect circle obtained by the approximation outputs the center coordinate value to the display section 71 as the coordinate value of the current position. On the display section 71, the current position may be displayed by, for example, latitude and longitude or may be displayed graphically together with map information.

Therefore, it is not necessary to use an expensive position detection device with a complicated correction function. By externally attaching the antenna device 8 to the position detection device 7 that uses a conventional GPS, the accuracy of determining the current position can be improved easily.

It should be understood that the means for rotating the antenna member 81 in the antenna device 8 is not limited to the electric motor 83 and it may be rotated by another drive source or an operator holding the position detection device 7 himself may rotate it circularly in a substantially horizontal direction at a substantially uniform speed so as to allow the tracking data to have a substantially circular shape.

As described above, according to Embodiment 3, signals are received from orbiting satellites, with the antenna member 81 provided, at an end thereof, with the GPS chip (the receiving section) 80 that receives the signals being rotated circularly in the horizontal direction at a substantially uniform speed. The coordinate values of the current position calculated based on the signals that have been received forms a substantially circular locus. Then the center coordinate value of the perfect circle obtained by the approximation of the locus of the coordinate values of the current position is determined as the coordinate value of the current position. This reduces the positioning error caused by, for example, the fluctuation resulting from satellite movement inherent to GPS. Thus the current position can be determined with higher accuracy.

### Embodiment 4

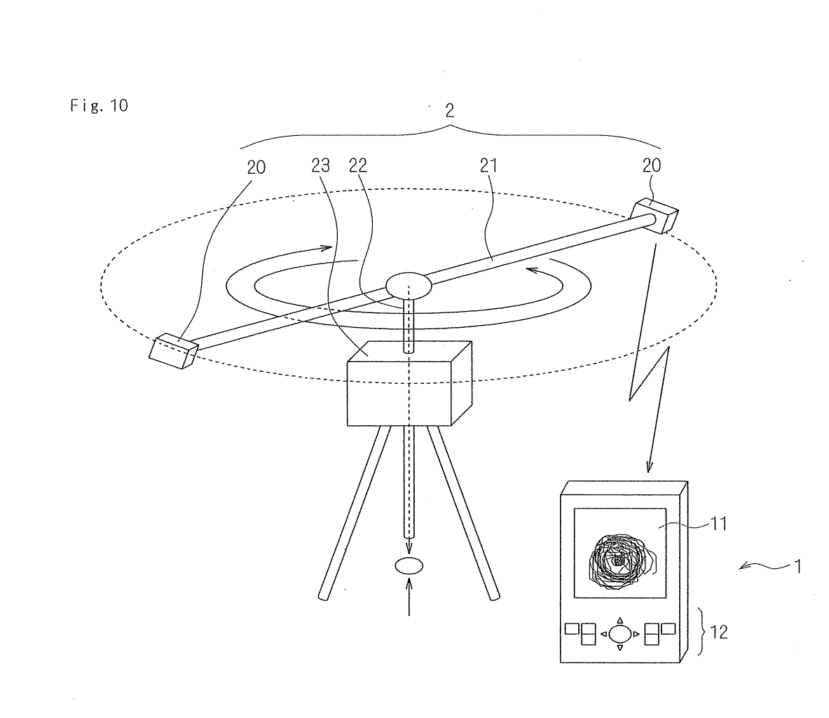

FIG. 10 is a schematic view showing the configuration of a position detection device according to Embodiment 4 of the present invention. As shown in FIG. 10, the position detection device 1 according to Embodiment 4 determines the current position using a GPS that receives signals from satellites orbiting around the earth to determine the current position.

The position detection device 1 is provided with an antenna main body 2 that receives signals from orbiting satellites, in such a manner as to be capable of data communication therewith, and receives the signals from orbiting satellites received by the antenna main body 2. The antenna main body 2 rotates an antenna member 21 circularly in the horizontal direction at a substantially uniform speed through a rotating shaft 22 that is located at an approximate center of the antenna member 21. Furthermore, the antenna member 21 is provided, at both ends thereof, with GPS chips (receiving sections) 20 for receiving the signals from satellites orbiting around the earth and is rotated by a swing device 23 provided with a drive source such as an electric motor as described later.

The result of determining the current position is displayed on a display section 11 as a coordinate value or with a coordinate value and map information overlapping each other. Various operations of the position detection device 1 are performed through an operation section 12.

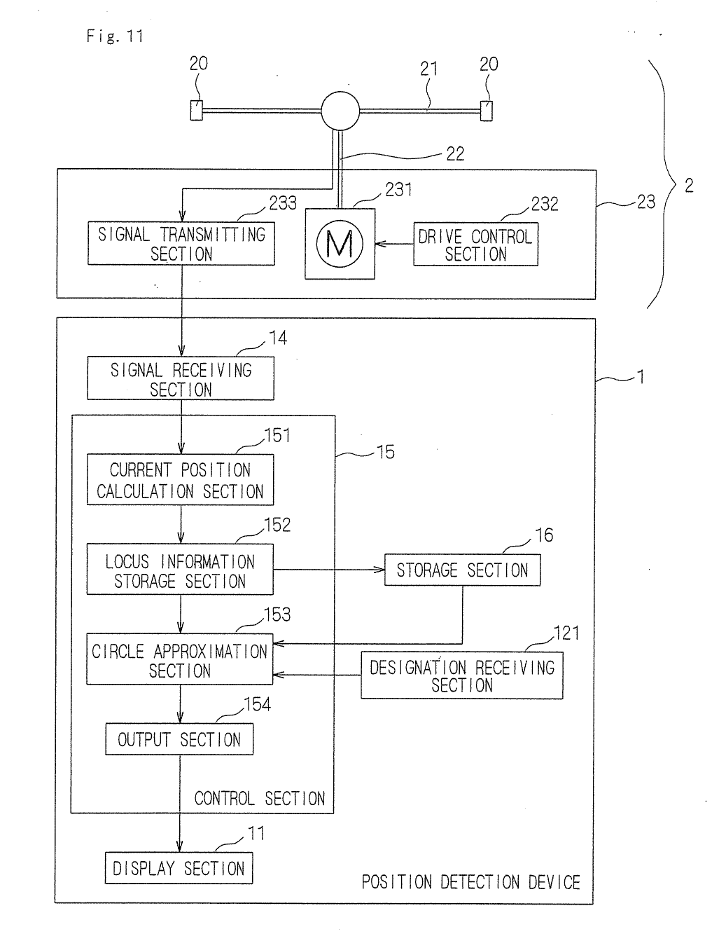

FIG. 11 is a functional block diagram showing the configuration of the position detection device 1 according to Embodiment 4 of the present invention. An electric motor (a rotation mechanism) 231 contained in the swing device 23 of the antenna main body 2 rotates the rotating shaft 22 based on a signal transmitted from a built-in drive control section 232. The antenna member 21 connected to the end of the rotating shaft 22 rotates circularly in the horizontal direction at a substantially uniform speed by the rotation of the rotating shaft 22. The GPS chips 20 provided at both ends of the antenna member 21 also rotate circularly in the horizontal direction at a substantially uniform speed.

The signals received by the two GPS chips 20 of the antenna main body 2 each are transmitted to the position detection device 1 through a signal transmitting section 233. The transmission of the signals from the signal transmitting section 233 to the position detection device 1 can be performed either by wired or by wireless.

The signals received by the two GPS chips 20 of the antenna main body 2 are received by a signal receiving section 14 of the position detection device 1 to be transmitted to a control section 15. A current position calculation section 151 of the control section 15 calculates the coordinate values of the current position based on the signals from orbiting satellites received by the antenna main body 2 respectively and then calculates the average coordinate value of the coordinate values that have been calculated. The method of calculating the coordinate values of the current position is not particularly limited as long as it is a well-known method.

A locus information storage section 152 stores, as tracking data, locus information about a locus of the average coordinate value of the coordinate values of the current position, which has been calculated, in a storage section 16 in chronological order. By storing it in the storage section 16 in chronological order, the tracking data to be used for determining the current position can be selected. The tracking data to be stored in the storage section 16 is information about a locus of the average coordinate value of the coordinate values of the current position obtained per sampling time.

When the tracking data is displayed on the display section 11, it may be displayed as a point sequence of average coordinate values and/or coordinate values of the current position obtained per sampling time or may be displayed after linear interpolation, spline interpolation, etc. are performed on the average coordinate values and/or the coordinate values of the current position obtained per sampling time.

A circle approximation section 153 approximates the tracking data stored in the storage section 16 to a perfect circle by using a well-known mathematical technique. The approximation may be performed on the tracking data obtained from the start of determining the current position or only on the tracking data obtained during the period designated through a designation receiving section 121 of the operation section 12. This allows the approximation to be performed, with a reduction in positioning error caused by the fluctuation that tends to occur in the early stage of position determination. Thus the approximation precision can be improved.

An output section 154 outputs the center coordinate value of the perfect circle obtained by the approximation by the circle approximation section 153 to the display section 11 as the coordinate value of the current position. Since the current position is determined based on the two signals obtained by measuring the same position, the current position can be determined with higher accuracy. On the display section 11, the current position may be displayed by, for example, latitude and longitude or may be displayed graphically together with map information.

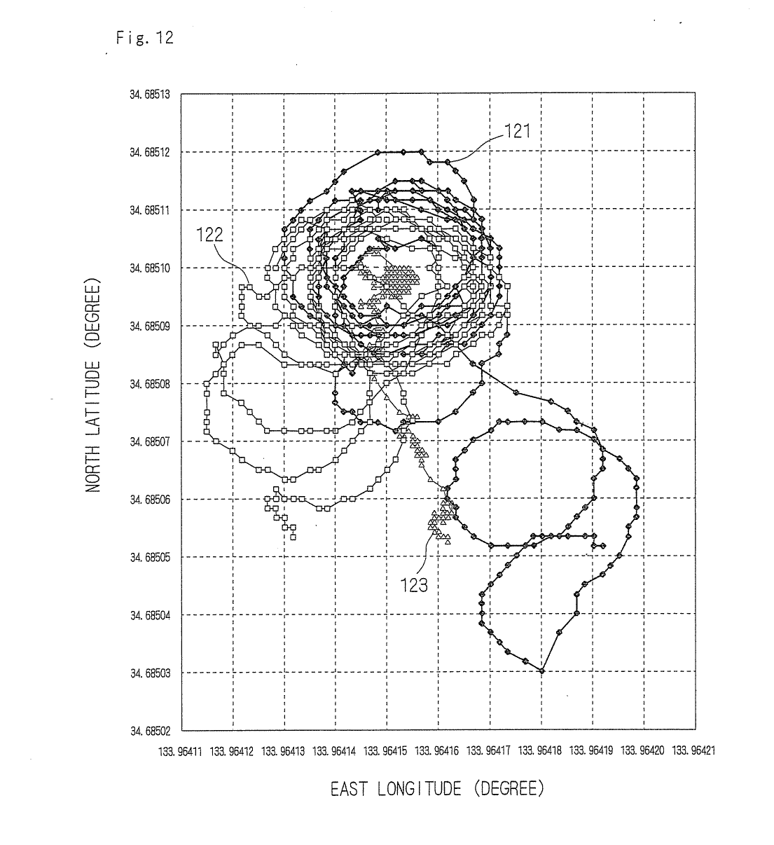

FIG. 12 is an illustrative view showing a method of displaying tracking data and a current position in the position detection device 1 according to Embodiment 4 of the present invention. FIG. 12 shows tracking data 123 of the average coordinate value and tracking data 121, 122 obtained based on the signals received by the two GPS chips 20 when the antenna member 21 was rotated circularly in the horizontal direction at a substantially uniform speed. The tracking data 121, 122, 123 displayed are obtained through linear interpolation of the average coordinate value and the coordinate values of the current position obtained per sampling time.

As shown in FIG. 12, with the antenna member 21 rotated circularly in the horizontal direction at a substantially uniform speed, the tracking data 121, 122 that have been moving around the true position randomly due to the movement of orbiting satellites and other effects converge in such a manner as to move about the true position circularly. That is, with the antenna member 21 being rotated about the rotating shaft 22 circularly in the horizontal direction at a substantially uniform speed, the signals from orbiting satellites are received by the GPS chips 20, so that the locus of the coordinate values of the current position calculated based on the signals that have been received has a substantially circular shape.

On the other hand, the tracking data 123 that indicates the average coordinate values of the tracking data 121, 122 has less variation as compared to the tracking data 121, 122 and converges to the true position in the early stage. Accordingly, the tracking data 123 of the average coordinate values can be approximated to a perfect circle with high precision. By determining the center coordinate value of the perfect circle obtained by the approximation as the coordinate value of the current position, the current position can be determined with high accuracy.

As described above, according to Embodiment 4, signals are received from orbiting satellites, with the antenna member 21 provided, at both ends thereof, with the GPS chips (the receiving sections) 20 that receive the signals being rotated circularly in the horizontal direction at a substantially uniform speed. The average coordinate value of the coordinate values of the current position calculated based on the signals that have been received is calculated. Then the center coordinate value of the perfect circle obtained by the approximation of the locus of the average coordinate values that have been calculated is determined as the coordinate value of the current position. This reduces the positioning error caused by, for example, the fluctuation resulting from satellite movement inherent to GPS. Thus the current position can be determined with higher accuracy.

### Embodiment 5

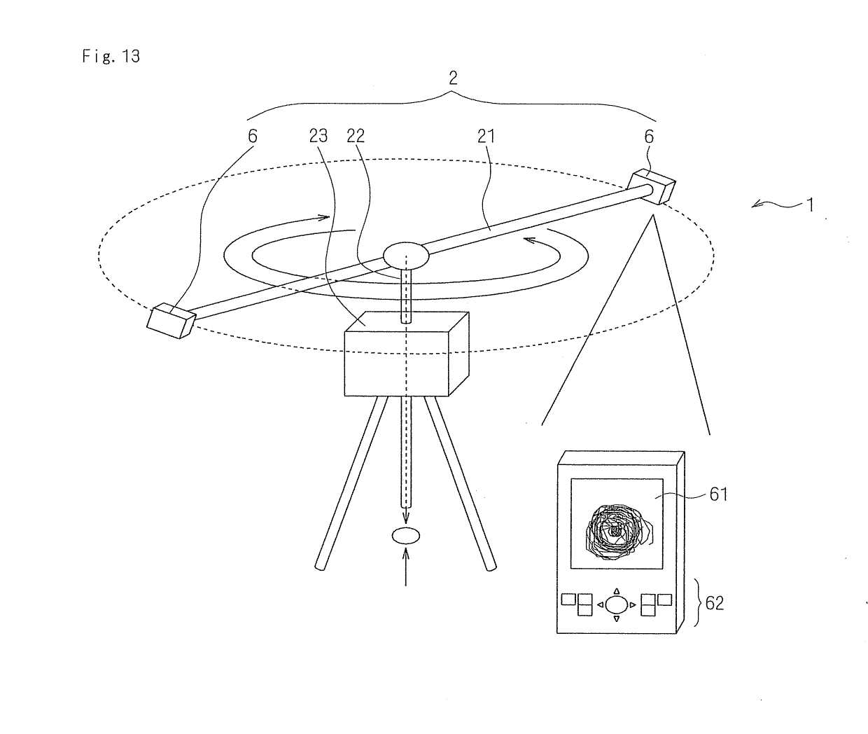

FIG. 13 is a schematic view showing the configuration of a position detection device 1 according to Embodiment 5 of the present invention. As shown in FIG. 13, the position detection device 1 according to Embodiment 5 is different from that of Embodiment 4 in that it is provided with conventional GPS devices 6 at both ends of an antenna member 21 and they are rotated together with the antenna member 21. The components and members with the same functions are indicated with the same numbers and detailed descriptions thereof are not repeated.

An antenna main body 2 rotates the antenna member 21 circularly in the horizontal direction at a substantially uniform speed through a rotating shaft 22 located at an approximate center of the antenna member 21. The antenna member 21 is rotated by a drive source such as an electric motor as described later that is contained in a swing device 23. It should be understood that the means for rotating the antenna member 21 is not limited to the electric motor and it may be rotated by another drive source or an operator holding the position detection device 1 himself may rotate it circularly in a substantially horizontal direction at a substantially uniform speed so as to allow the tracking data to have a substantially circular shape.

The result of determining the current position is displayed on a display section 61 of each GPS device 6 as a coordinate value or with a coordinate value and map information overlapping each other. Various operations of each GPS device 6 are performed through an operation section 62.

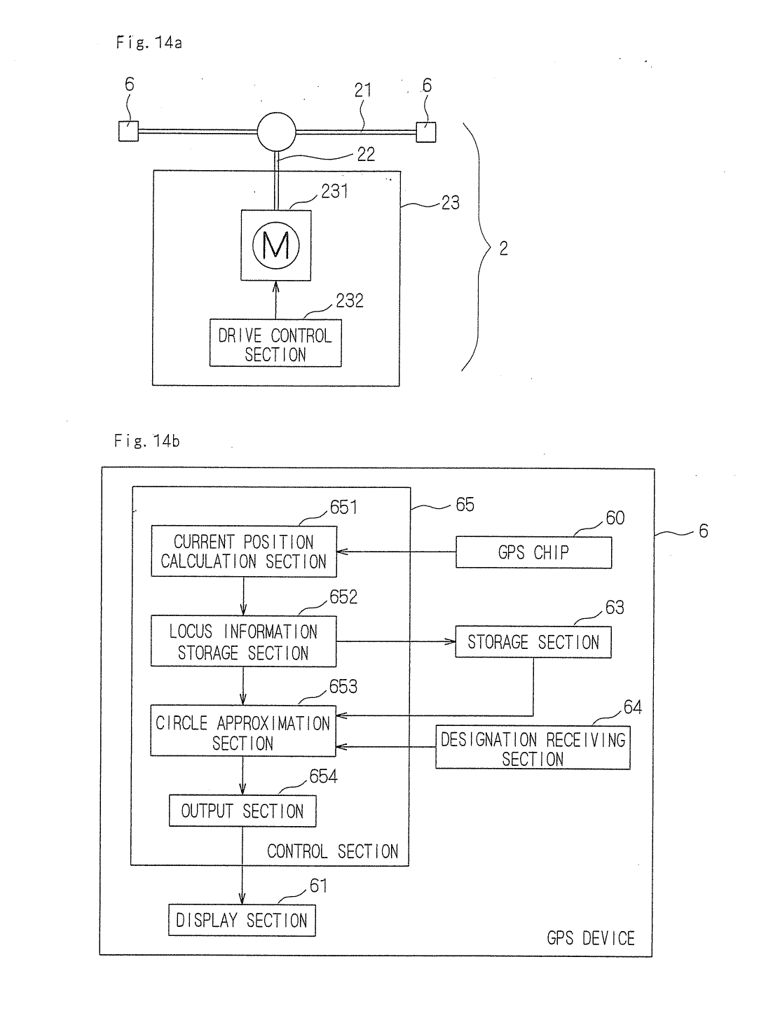

FIG. 14 is a functional block diagram showing the configuration of the position detection device 1 according to Embodiment 5 of the present invention. FIG. 14A is a functional block diagram showing the configuration of the antenna main body 2 of the position detection device 1 according to Embodiment 5 of the present invention. As shown in FIG. 14A, the rotating shaft 22 is rotated by the electric motor (the rotation mechanism) 231 contained in the swing device 23 of the antenna main body 2. The antenna member 21 connected to the end of the rotating shaft 22 rotates circularly in the horizontal direction at a substantially uniform speed by the rotation of the rotating shaft 22. The GPS devices 6 provided at both ends of the antenna member 21 also rotate circularly in the horizontal direction at a substantially uniform speed.

FIG. 14B is a functional block diagram showing the configuration of the GPS device 6 of the position detection device 1 according to Embodiment 5 of the present invention. As shown in FIG. 14B, a signal received by a GPS chip (a receiving section) 60 of the GPS device 6 that is rotating is transmitted to a control section 65. A current position calculation section 651 of the control section 65 calculates the coordinate values of the current position based on the signals from orbiting satellites received by the two GPS chips 60, respectively, and then calculates the average coordinate value of the coordinate values thus calculated. The method of calculating the coordinate values of the current position is not particularly limited as long as it is a well-known method.

A locus information storage section 652 stores, as tracking data, locus information about a locus of the average coordinate values of the coordinate values of the current position, which have been calculated, in a storage section 63 in chronological order. By storing it in the storage section 63 in chronological order, the tracking data to be used for determining the current position can be selected. The tracking data to be stored in the storage section 63 is information about a locus of the average coordinate values of the coordinate values of the current position obtained per sampling time.

When the tracking data is displayed on the display section 61, it may be displayed as a point sequence of average coordinate values and/or coordinate values of the current position obtained per sampling time or may be displayed after linear interpolation, spline interpolation, etc. are performed on the average coordinate values and/or the coordinate values of the current position obtained per sampling time.

A circle approximation section 653 approximates the tracking data stored in the storage section 63 to a perfect circle by using a well-known mathematical technique. The approximation may be performed on the tracking data obtained from the start of determining the current position or only on the tracking data obtained during the period designated through a designation receiving section 64 of the operation section 62. This allows the approximation to be performed, with a reduction in positioning error caused by the fluctuation that tends to occur in the early stage of position determination. Thus the approximation precision can be improved.

An output section 654 outputs the center coordinate value of the perfect circle obtained by the approximation by the circle approximation section 653 to the display section 61 as the coordinate value of the current position. Since the current position is determined based on the two signals obtained by measuring of the same position, the current position can be determined with higher accuracy. On the display section 61, the current position may be displayed by, for example, latitude and longitude or may be displayed graphically together with map information.

As described above, according to Embodiment 5, signals are received from orbiting satellites, with the antenna member 21 provided, at both ends thereof, with the GPS chips (the receiving sections) 60 that receive the signals being rotated circularly in the horizontal direction at a substantially uniform speed. The average coordinate value of the coordinate values of the current position calculated based on the signals that have been received is calculated. Then the center coordinate value of the perfect circle obtained by the approximation of the locus of the average coordinate values that have been calculated is determined as the coordinate value of the current position. This reduces the positioning error caused by, for example, the fluctuation resulting from satellite movement inherent to GPS. Thus the current position can be determined with higher accuracy.

### Embodiment 6

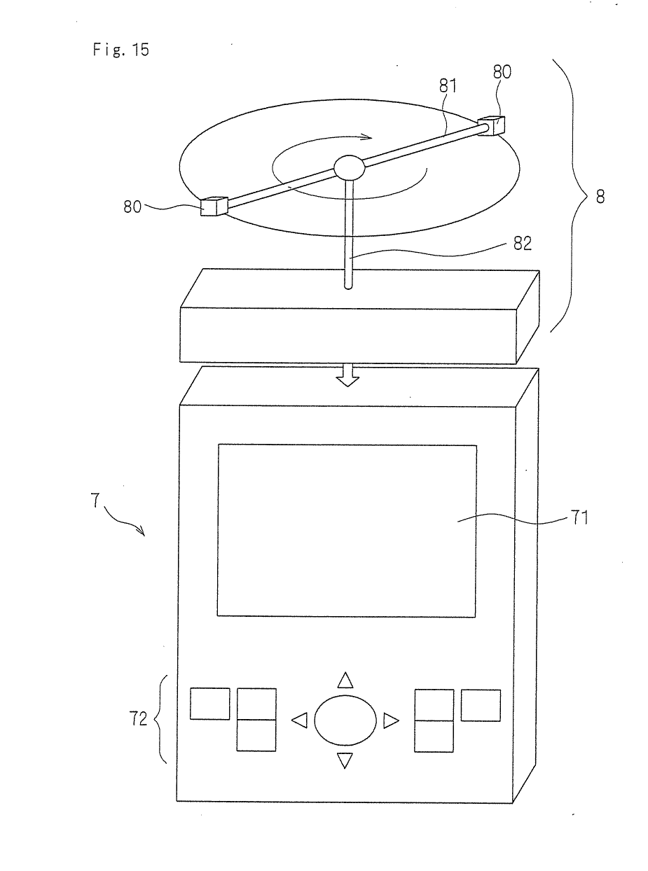

FIG. 15 is a schematic view showing the configuration of an antenna device according to Embodiment 6 of the present invention. As shown in FIG. 15, the antenna device 8 according to Embodiment 6 receives signals from satellites orbiting around the earth and transmits a signal indicating the current position based on the signals that have been received, to a position detection device 7.

The antenna device 8 circularly rotates an antenna member 81 through a rotating shaft 82, which is located at an approximate center of the antenna member 81, in the horizontal direction at a substantially uniform speed. The antenna member 81 is provided, at both ends thereof, with GPS chips (receiving sections) 80 that receive signals from satellites orbiting around the earth and is rotated by a drive source such as an electric motor as described later.

The result of determining the current position is outputted to the position detection device 7 as a signal indicating the current position. The position detection device 7 that has received the signal indicating the current position displays the result of determining the current position on a display section 71 as a coordinate value or with a coordinate value and map information overlapping each other. Various operations of the position detection device 7 are performed through an operation section 72.

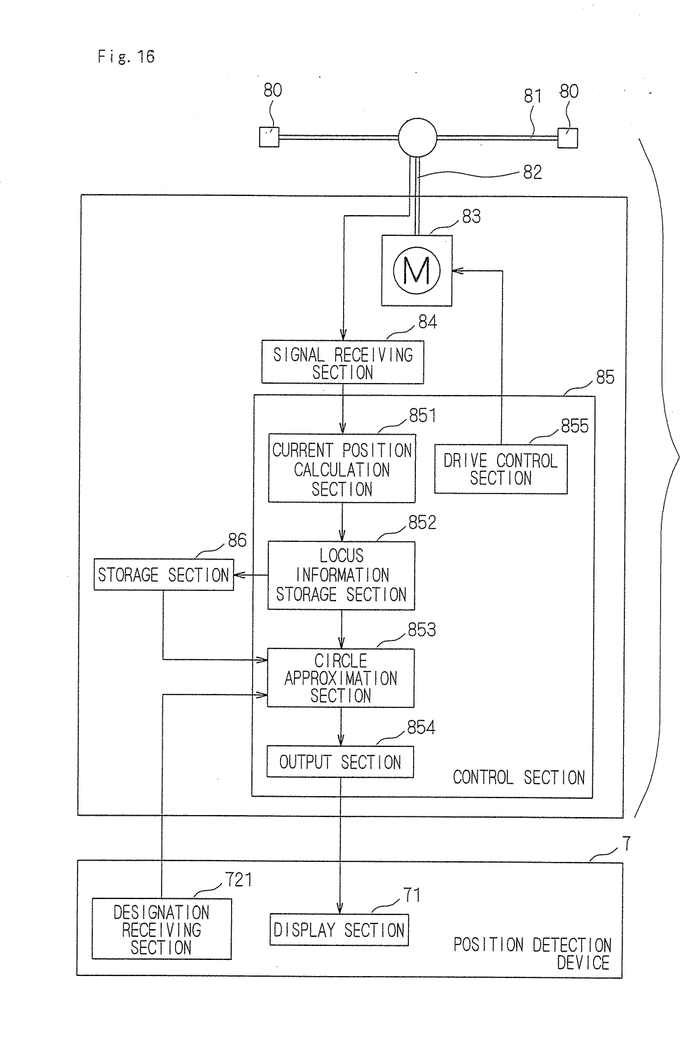

FIG. 16 is a functional block diagram showing the configuration of the antenna device 8 according to Embodiment 6 of the present invention. An electric motor (a rotation mechanism) 83 contained in the antenna device 8 rotates the rotating shaft 82 based on a signal transmitted from a drive control section 855 of a control section 85. The antenna member 81 connected to the end of the rotating shaft 82 rotates circularly in the horizontal direction at a substantially uniform speed by the rotation of the rotating shaft 82.

Signals received by the GPS chips 80 provided at both ends of the antenna member 81 are received by a signal receiving section 84 to be transmitted to the control section 85. A current position calculation section 851 of the control section 85 calculates the coordinate values of the current position based on the signals from orbiting satellites received by the two GPS chips 80, respectively, and then calculates the average coordinate value of the coordinate values thus calculated. The method of calculating the coordinate values of the current position is not particularly limited as long as it is a well-known method.

A locus information storage section 852 stores, as tracking data, locus information about a locus of the average coordinate values of the coordinate values of the current position, which have been calculated, in a storage section 86 in chronological order. By storing it in the storage section 86 in chronological order, the tracking data to be used for determining the current position can be selected. The tracking data to be stored in the storage section 86 is information about a locus of the average coordinate values of the coordinate values of the current position obtained per sampling time.

When the tracking data is displayed on the display section 71 of the position detection device 7, it may be displayed as a point sequence of average coordinate values and/or coordinate values of the current position obtained per sampling time or may be displayed after linear interpolation, spline interpolation, etc. are performed on the average coordinate values and/or the coordinate values of the current position obtained per sampling time.

A circle approximation section 853 approximates the tracking data stored in the storage section 86 to a perfect circle by using a well-known mathematical technique. The approximation may be performed on the tracking data obtained from the start of determining the current position or only on the tracking data obtained during the period designated through a designation receiving section 721 of the operation section 72. This allows the approximation to be performed, with a reduction in positioning error caused by the fluctuation that tends to occur in the early stage of position determination. Thus the approximation precision can be improved.

An output section 854 outputs the center coordinate value of the perfect circle obtained by the approximation by the circle approximation section 853 to the position detection device 7 as a signal indicating the current position. The position detection device 7 that has received the center coordinate value of the perfect circle obtained by the approximation outputs the center coordinate value to the display section 71 as the current position. On the display section 71, the current position may be displayed by, for example, latitude and longitude or may be displayed graphically together with map information.

Therefore, it is not necessary to use an expensive position detection device with a complicated correction function. By externally attaching the antenna device 8 to the position detection device 7 that uses a conventional GPS, the accuracy of determining the current position can be improved easily.

It should be understood that the means for rotating the antenna member 81 in the antenna device 8 is not limited to the electric motor 83 and it may be rotated by another drive source or an operator holding the position detection device 7 himself may rotate it circularly in a substantially horizontal direction at a substantially uniform speed so as to allow the tracking data to have a substantially circular shape.

As described above, according to Embodiment 6, signals are received from orbiting satellites, with the antenna member 81, to both ends of which the GPS chips (the receiving sections) 80 that receive the signals are attached, being rotated circularly in the horizontal direction at a substantially uniform speed. The average coordinate value of the coordinate values of the current position calculated based on the signals that have been received is calculated. Then the center coordinate value of the perfect circle obtained by the approximation of the locus of the average coordinate values that have been calculated is determined as the coordinate value of the current position. This reduces the positioning error caused by, for example, the fluctuation resulting from satellite movement inherent to GPS. Thus the current position can be determined with higher accuracy.

The present invention is not limited to the examples described above and can be subjected to various alterations, modifications, etc., as long as they are within the spirit of the present invention. On the display section 11 (61, 71), for example, as tracking data to be approximated to a perfect circle, a point sequence of average coordinate values and/or coordinate values of the current position obtained per sampling time may be displayed, or a perfect circle obtained by the approximation and the coordinate value that indicates the current position may be displayed together. Furthermore, in Embodiments 4 to 6, the current position is determined based on two signals obtained by measuring of the same position, but the number of the signals are not limited to two and the current position can be determined based on a plurality of signals.

### DESCRIPTIONS OF NUMBERS

1, 7 Position Detection Device

2 Antenna Main Body

6 GPS Device

8 Antenna Device

20, 60, 80 GPS Chip (Receiving Section)

21, 81 Antenna Member

83, 231 Electric Motor (Rotation Mechanism)

Although a few embodiments of the present invention have been shown and described, it would be appreciated by those skilled in the art that changes may be made in this embodiment without departing from the principles and spirit of the invention, the scope of which is defined in the claims and their equivalents.

1. A position detection device that determines a current position using a GPS that receives a signal from a satellite orbiting around the earth to determine the current position,
wherein the position detection device is capable of data communication with an antenna main body that comprises:
an antenna member provided, at an end thereof, with a receiving section for receiving the signal from the orbiting satellite; and
a rotation mechanism for rotating the antenna member circularly in a horizontal direction at a substantially uniform speed, and
the position detection device receives the signal from the orbiting satellite received by the receiving section.

2. The position detection device according to claim 1, wherein the position detection device comprises:
a calculation means that calculates a coordinate value of the current position based on the signal received from the orbiting satellite;
a locus information storage means that stores locus information about a locus of the coordinate value of the current position that has been calculated;
an approximation means that approximates the locus of the coordinate value of the current position to a perfect circle based on the locus information that has been stored; and
an output means that outputs, as a coordinate value of the current position, a center coordinate value of the perfect circle obtained by the approximation.

3. The position detection device according to claim 1, wherein
the antenna member rotates about an approximate center thereof in the horizontal direction and is provided, at each end thereof, with the receiving section.

4. The position detection device according to claim 3, wherein the position detection device comprises:
a calculation means that calculates the coordinate values of the current position based on the signals from the orbiting satellite received by the receiving sections, respectively;
a locus information storage means that calculates the average coordinate value of the coordinate values of the current position that have been calculated and stores locus information about a locus of the average coordinate value that has been calculated;
an approximation means that approximates the locus information of the current position to a perfect circle based on the locus information that has been stored; and
an output means that outputs, as a coordinate value of the current position, a center coordinate value of the perfect circle obtained by the approximation.

5. The position detection device according to claim 2, wherein the approximation means selects locus information for a predetermined period of time from the locus information that has been stored and then approximates it to a perfect circle.

6. A position detection method for determining a current position using a GPS that receives a signal from a satellite orbiting around the earth to determine the current position,
wherein the position detection method comprises:
a step of rotating an antenna member circularly in a horizontal direction at a substantially uniform speed, which is provided, at an end thereof, with a receiving section for receiving the signal from the orbiting satellite; and
a step of receiving the signal from the orbiting satellite by the receiving section, with the antenna member being rotated.

7. The position detection method according to claim 6, wherein the position detection method comprises:
a step of calculating a coordinate value of the current position based on the signal received from the orbiting satellite;
a step of storing locus information about a locus of the coordinate value of the current position that has been calculated;
a step of approximating the locus of the coordinate value of the current position to a perfect circle based on the locus information that has been stored; and
a step of outputting, as a coordinate value of the current position, a center coordinate value of the perfect circle obtained by the approximation.

8. The position detection method according to claim 6, wherein the antenna member rotates about an approximate center thereof in the horizontal direction and is provided, at each end thereof, with the receiving section.

9. The position detection method according to claim 8, wherein the position detection method comprises:
a step of calculating coordinate values of the current position based on the signals from the orbiting satellite received by the receiving sections, respectively;
a step of calculating the average coordinate value of the coordinate values of the current position that have been calculated and storing locus information about a locus of the average coordinate value that has been calculated;
a step of approximating the locus information of the current position to a perfect circle based on the locus information that has been stored; and
a step of outputting, as a coordinate value of the current position, a center coordinate value of the perfect circle obtained by the approximation.

10. The position detection method according to claim 7, wherein locus information for a predetermined period of time is selected from the locus information that has been stored and then is approximated to a perfect circle.

11. An antenna device for position detection that receives a signal from a satellite orbiting around the earth and transmits, based on the signal thus received, a signal indicating a current position to a position detection device,
wherein the antenna device comprises:
an antenna member provided, at an end thereof, with a receiving section for receiving the signal from the orbiting satellite; and
a rotation mechanism for rotating the antenna member circularly in a horizontal direction at a substantially uniform speed.

12. The antenna device for position detection according to claim 11, wherein the antenna device comprises:
a calculation means that calculates a coordinate value of the current position based on the signal received from the orbiting satellite;
a locus information storage means that stores locus information about a locus of the coordinate value of the current position that has been calculated;
an approximation means that approximates the locus of the coordinate value of the current position to a perfect circle based on the locus information that has been stored; and
an output means that outputs, as a signal indicating the current position, a center coordinate value of the perfect circle obtained by the approximation to the position detection device.

13. The antenna device according to claim 11, wherein the antenna member rotates about an approximate center thereof in the horizontal direction and is provided, at each end thereof, with the receiving section.

14. The antenna device for position detection according to claim 13, wherein the antenna device comprises:
a calculation means that calculates coordinate values of the current position based on the signals from the orbiting satellite received by the receiving sections, respectively;
a locus information storage means that calculates the average coordinate value of the coordinate values of the current position that have been calculated and stores locus information about a locus of the average coordinate value that has been calculated;
an approximation means that approximates the locus of the current position to a perfect circle based on the locus information that has been stored; and
an output means that outputs, as a signal indicating the current position, a center coordinate value of the perfect circle obtained by the approximation to the position detection device.

15. The position detection device according to claim 4, wherein the approximation means selects locus information for a predetermined period of time from the locus information that has been stored and then approximates it to a perfect circle.

16. The position detection method according to claim 9, wherein locus information for a predetermined period of time is selected from the locus information that has been stored and then is approximated to a perfect circle.
